(19) United States
(12) Patent Application Publication
(10) Pub. No.: US 2008/0291113 A1
(43) Pub. Date: Nov. 27, 2008

(54) ANTENNA SWITCHING SYSTEM AND RELATED METHOD FOR SWITCHING BETWEEN FIRST AND SECOND ANTENNAS HAVING DIFFERENT GAINS

(76) Inventor: Cheng-Yi Ou-Yang, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/751,043

(22) Filed: May 21, 2007

(51) Int. Cl. H01Q 21/30

(52) U.S. Cl. 343/876

(57) ABSTRACT

An antenna switching system for switching between a first antenna and a second antenna, where a gain of the first antenna is different from a gain of the second antenna, is disclosed. The antenna switching system includes an antenna switch unit and a switch control device. The antenna switch unit is selectively coupled to the first antenna or the second antenna. The switch control device is coupled to the antenna switch unit and utilized for controlling the antenna switch unit to switch between the first antenna and the second antenna according to at least a predetermined threshold value and an incoming wireless signal received from the antenna switch unit to achieve some purposes such as reducing power consumption and anti-jamming.

### BACKGROUND

The present invention relates to a wireless receiving scheme, and more particularly, to an antenna switching system and related method for controlling an antenna switch unit to switch between a first antenna and a second antenna.

Generally speaking, antennas in wireless receiving systems are necessary components. For common wireless receiving systems (e.g. wireless transceivers or radio receivers), antennas are usually integrated within the receiving systems before selling. There is less possibility for users to plug in extra antenna(s) to the receiving systems. However, in other wireless receiving systems, such as GNSS receiving systems (Global Navigation Satellite System, including GPS, Galileo . . . ) or mobile phones, an antenna port will be provided for users to plug in another antenna (which is usually referred to as a car kit port). An advantage of being able to plug in another antenna is that the wireless receiving systems can still provide a better signal receptivity even if signal levels of received transmission signals are at a poor level. One disadvantage, however, is that the function of the antenna integrated within the wireless receiving system is disabled. Currently, for design of a GNSS receiving system (e.g. a GPS receiving system), a passive antenna is integrated within the GNSS receiving system and an antenna port is reserved in advance for accommodating an externally plugged in active antenna. The active antenna is powered by a DC current provided from the GNSS receiving system. Please refer to FIG. 1 in conjunction with FIG. 2. FIG. 1 is a diagram of a conventional GPS receiving system 100 without an external active antenna plugged in. FIG. 2 is a diagram of the GPS receiving system 100 shown in FIG. 1 with an external active antenna 225 plugged in. The GPS receiving system 100 includes an antenna port 105, an antenna switch unit 110, an RF choke unit 115, a DC block unit 120, a passive antenna 125, and a receiving device 130. As shown in FIG. 1, since no external antenna is coupled to the GPS receiving system 100 at present, the receiving device 130 controls the antenna switch unit 110 to couple to the passive antenna 125 and therefore an incoming wireless signal (i.e. a GPS navigation signal) received from the passive antenna 125 is transmitted into the receiving device 130 through the antenna switch unit 110 and the DC block unit 120 (the DC block unit 120 also provides AC or RF signal coupling function). When plugging in the external antenna 225 (as shown in FIG. 2), the receiving device 130 controls the antenna switch unit 110 to couple to the active antenna 225 instead of the passive antenna 125 and then the GPS navigation signal is received from the active antenna 225 and transmitted into the receiving device 130 through the antenna port 105, the antenna switch unit 110, and the DC block unit 120. Usually, the active antenna 225 further includes a low noise amplifier (LNA) 230, which is powered by a DC current provided from the receiving device 130 passing through the RF choke unit 115 and the antenna port 105. An antenna gain A₂ of the active antenna 225 is often greater than that of the passive antenna 125 (i.e. A₁). Accordingly, receiving sensitivity of the GPS receiving system 100 can be improved by utilizing the active antenna 225. In general, the receiving sensitivity has almost a 2˜5 dB increase.

Another advantage of the active antenna 225 is that it can be designed to provide a better performance than that provided by the passive antenna 125. This is because performance provided by the passive antenna 125 built within the GPS receiving system 100 is usually limited due to a product size and related mechanical design of the GPS receiving system 100. Particularly, in the future, it will be required that the passive antenna 125 become much smaller for handheld consumer devices. In other words, for designers, designing the active antenna 225 is simpler than designing the passive antenna 125. As mentioned above, the passive antenna 125 is disabled and only the active antenna 225 is utilized for receiving the GPS navigation signal if the GPS receiving system 100 operates under an environment having a low SNR/CNR with respect to the GPS navigation signal.

It should be noted that after plugging in the active antenna 225, the receiving device 130 controls the antenna switch unit 110 to couple to the antenna port 105 for receiving the GPS navigation signal from the active antenna 225 continuously unless the active antenna 225 is not plugged in. That is, even though only the passive antenna 125 is sufficient for signal reception under an environment having a high SNR/CNR with respect to the GPS navigation signal, the GPS receiving system 100 still continuously provides a DC current for the active antenna 225 to use for signal reception since the active antenna 225 is still coupled to the GPS receiving system 100. The battery life of the GPS receiving system 100 will therefore be reduced by a wide margin.

For example, if the GPS receiving system 100 is positioned within a car, there is a possibility that the received GPS navigation signal is below a predetermined signal level so it is better to utilize the active antenna 225 instead of using the passive antenna 125 for reception. Once the GPS navigation signal is above the predetermined signal level, however, it is possible that using the passive antenna 125 instead of the active antenna 225 is better. If the GPS receiving system 100 always provides the DC current for the active antenna 225 to use the active antenna 225 for signal reception, then the battery life of the GPS receiving system 100 will become shorter. In general, the DC current provided for the active antenna 225 is required to be almost 7˜15 mA, which is almost 25˜50 percent of a total current consumed by the GPS receiving system 100. Furthermore, the GPS navigation signal may only become weak under some particular environments. This method of always using the active antenna 225 when it is plugged in decreases the power efficiency.

Furthermore, another problem is that the GPS receiving system 100 that uses the active antenna 225 for signal reception is easily saturated with a jamming signal source. For example, when a car where the GPS receiving system 100 is positioned moves near to a base station, the GPS navigation signal may be interfered with by a transmission signal generated from the base station (in this situation, this transmission signal is regarded as a jamming signal). Since energy of the jamming signal is usually much greater than that of the GPS navigation signal, it is possible that some circuits within the GPS receiving system 100 will be saturated if the active antenna 225 is constantly used for receiving the GPS navigation signal. In this situation, utilizing the passive antenna 125 instead of the active antenna 225 for reception is much better.

### SUMMARY

It is therefore one of the objectives of the present invention to provide an antenna switching system and related method for controlling an antenna switch unit to switch between a first antenna and a second antenna (a gain of the first antenna being different from that of the second antenna) according to at least a predetermined threshold value and an incoming wireless signal received from the antenna switch unit, to solve the above-mentioned problems.

According to an embodiment of the present invention, an antenna switching system for switching between a first antenna and a second antenna, where a gain of the first antenna is different from a gain of the second antenna, is disclosed. The antenna switching system comprises an antenna switch unit and a switch control device. The antenna switch unit is selectively coupled to the first antenna or the second antenna. The switch control device is coupled to the antenna switch unit and utilized for controlling the antenna switch unit to switch between the first antenna and the second antenna according to at least a predetermined threshold value and an incoming wireless signal received from the antenna switch unit.

According to an embodiment of the present invention, an antenna switching method is disclosed. The antenna switching method comprises: providing a first antenna and a second antenna, where a gain of the first antenna is different from a gain of the second antenna; providing an antenna switch unit selectively coupled to the first antenna or the second antenna; and controlling the antenna switch unit to switch between the first antenna and the second antenna according to at least a predetermined threshold value and an incoming wireless signal received from the antenna switch unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional GPS receiving system without an external active antenna plugged in.

FIG. 2 is a diagram of the GPS receiving system shown in FIG. 1 with an external active antenna plugged in.

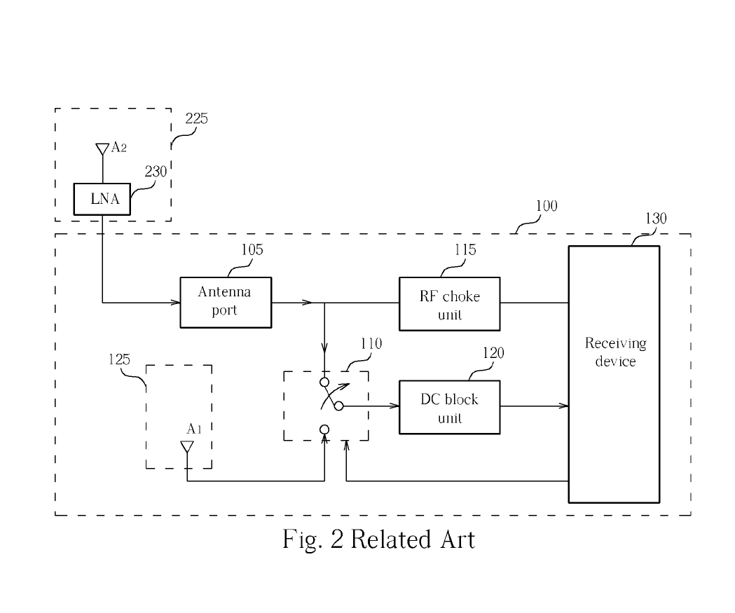

FIG. 3 is a diagram of an antenna switching system according to an embodiment of the present invention.

FIG. 4 is a circuit schematic diagram of an example of integrating operations of the antenna check unit and antenna current supply shown in FIG. 3.

FIG. 5 is a flowchart showing an operation of the antenna switching system for achieving optimal power efficiency.

FIG. 6 is a flowchart showing an operation of the antenna switching system for achieving anti-jamming.

FIG. 7 shows a table illustrating various examples of receiving the GPS navigation signal Sin in different environments by using the active antenna or the passive antenna.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

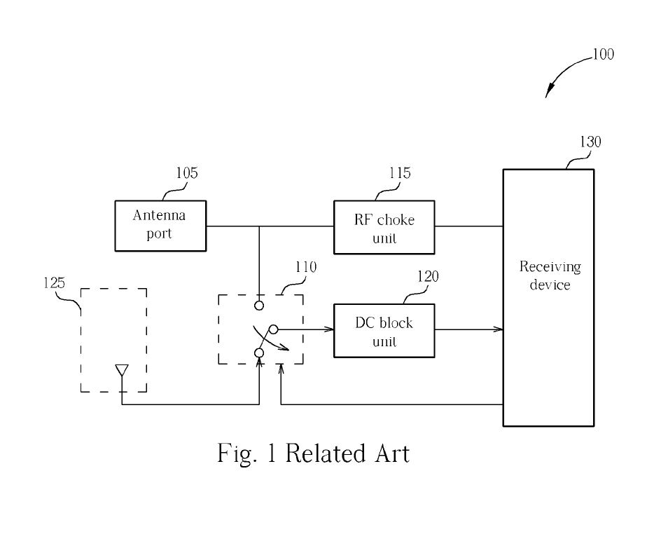

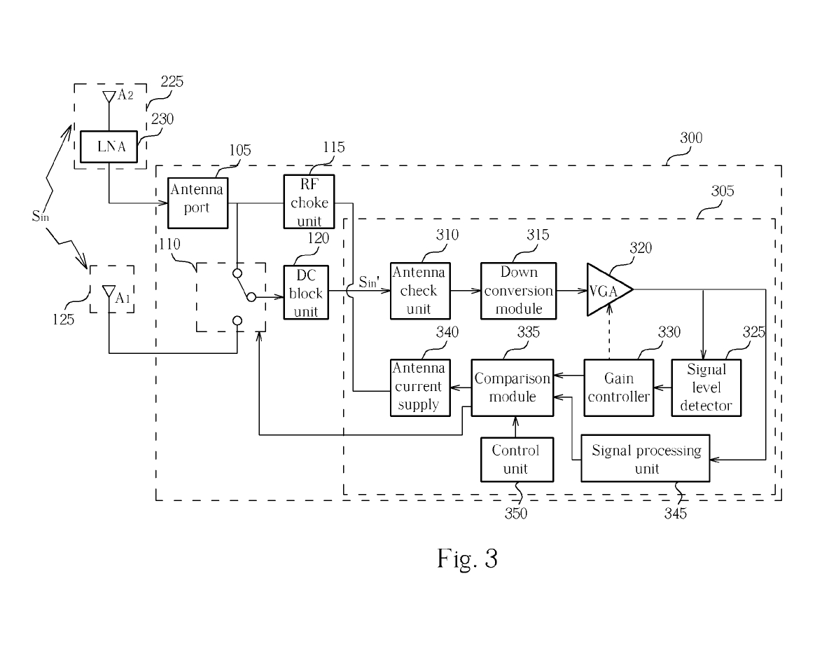

Please refer to FIG. 3. FIG. 3 is a diagram of an antenna switching system 300 according to an embodiment of the present invention. In the following, the antenna switching system 300 in this embodiment is based on the Global Positioning System (GPS) for illustrative purposes; however, the spirit of the present invention can also be applied to another antenna switching system for selectively using a first antenna or a second antenna having a gain different from that of the first antenna for signal reception, such as another antenna switching system based on the Beidou navigation system or the Galileo positioning system. Please note that the first and second antennas can be two active antennas having different gains or two passive antennas having different gains, or one of the first and second antennas is an active antenna and the other is a passive antenna, and these modifications also obey the spirit of the present invention. For simplicity, in this embodiment, the active antenna 225 is utilized for playing a role of the first antenna and the passive antenna 125 is utilized for playing a role of the second antenna; however, this is not intended to be a limitation of the present invention. As shown in FIG. 3, the antenna switching system 300 comprises the antenna port 105, the antenna switch unit 110, the RF choke unit 115, the DC block unit 120, and a switch control device 305. It should be noted that the active antenna 225 in this embodiment may not be plugged in yet to the antenna switching system 300; however, in FIG. 3, it is shown that the active antenna 225 has been coupled to the antenna port 105, for describing how the switch control device 305 in the antenna switching system 300 controls the antenna switch unit 110 to switch between the active antenna 225 and the second antenna 125. Besides having a receiving function identical to that of the receiving device 130 of FIG. 1, the switch control device 305 is further utilized for controlling the antenna switch unit 110 to switch between the active antenna 225 and the passive antenna 125 according to at least a predetermined threshold value and an incoming wireless signal Sᵢₙ′ received from the antenna switch unit 110 through the DC block unit 120. The wireless signal Sᵢₙ′ corresponds to a GPS navigation signal Sin, which is transmitted from a satellite and received by the active antenna 225 or the passive antenna 125. That is, the switch control device 305 can control the antenna switch unit 110 to selectively use the active antenna 225 or the passive antenna 125 for receiving the GPS navigation signal Sin, to achieve anti-jamming and power efficiency.

Specifically, the switch control device 305 includes an antenna check unit 310, a down conversion module 315, a variable gain amplifier (VGA) 320, a signal level detector 325, a gain controller 330, a comparison unit 335, an antenna current supply 340, a signal processing unit 345, and a control unit 350. The antenna check unit 310 is utilized for checking the active antenna 225 to see whether the active antenna 225 operates correctly, and the antenna current supply 340 is controlled by the antenna check unit 310 for providing the LNA 230 with a DC current if the active antenna 225 operates correctly. In other words, when the active antenna 225 is plugged in to the antenna switching system 300, the antenna check unit 310 can immediately detect and check a status of the active antenna 225. If the active antenna 225 is short, the antenna switching system 300 will instantly stop providing the DC current for the LNA 230.

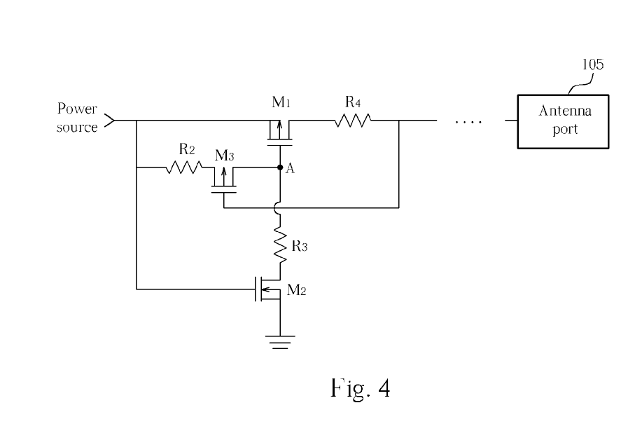

Please refer to FIG. 4. FIG. 4 is a circuit schematic diagram of an example for integrating operations of the antenna check unit 310 and the antenna current supply 340 shown in FIG. 3. When the active antenna 225 is not yet plugged in to the wireless receiving system 300, a transistor M₂ is conductive so that a voltage level at a node A is regarded as a low logic level and a transistor M₁ is conductive. In this situation, no DC current is consumed by the antenna port 105. When the active antenna 225 is plugged in to the antenna port 105, the voltage level at a node A is still maintained at the low logic level, but a voltage drop resulting from the DC current provided for the active antenna 225 exists between a resistor R₄ so that a voltage level at the antenna port 105 will be slightly lower than that provided by a power source. Once the active antenna 225 coupled to the antenna port 105 is short, a transistor M₃ is conductive since the voltage level at the antenna port 105 is regarded as a low logic level. The voltage level at the node A is therefore changed to a high logic level such that the transistor M₁ is not conductive and no DC current is provided for the active antenna 225.

Accordingly, the active antenna 225 can be checked before the wireless receiving system 300 receives the GPS navigation signal Sᵢₙ from the active antenna 225. Of course, a resistance of the resistor R₄ can also be designed for providing over-current protection. For instance, if the voltage level provided from the power source is designed to be 4 Volts, then the resistance of the resistor R₄ can be designed to be 10 Ohms. Consequently, the transistor M₁ will be turned off if the DC current provided for the antenna port 105 exceeds 400 mA.

If it is ensured that the active antenna operates correctly, the down conversion module 315 then down-converts the wireless signal Sᵢₙ′ passing through the antenna check unit 310 and performs a low-pass filtering operation for generating a low frequency signal. The low frequency signal is amplified to be within a signal level range that can be processed by the signal processing unit 345, where the signal processing unit 345 usually includes analog-to-digital converters (ADCs) and any digital/analog processing modules. The amplifying operation is completed by the VGA 320, the signal level detector 325, and the gain controller 330, where the gain controller 330 can be a programmable gain controller or an automatic gain controller.

As mentioned above, when the signal level detector 325 detects that a signal level of an output signal from the VGA 320 corresponding to the wireless signal Sᵢₙ′ is lower, an indicating signal generated from the signal level detector 325 is transmitted to the gain controller 330 and then the gain controller 330 determines a higher gain value assigned to the VGA 320 until the signal level of the output signal meets a requirement of the signal processing unit 345. When the signal level of the output signal is higher, the indicating signal is transmitted to the gain controller 330 for determining a lower gain value assigned to the VGA 320 until the signal level of the output signal meets the requirement of the signal processing unit 345. Please note that the gain value determined by the gain controller 330 is transmitted to the comparison unit 335 and a detected CNR/SNR value from the signal processing unit 345 is also transmitted to the comparison unit 335. In addition, in this embodiment, the control unit 350 sets two predetermined threshold values including a predetermined CNR/SNR value and a predetermined gain value and sends these values to the comparison unit 335. The comparison unit 335 can therefore turn on/off the antenna current supply 340 for indirectly controlling the antenna switch unit 110 to switch between the active antenna 225 and the passive antenna 125 by comparing the detected CNR/SNR value with the predetermined CNR/SNR value or by comparing the gain value with the predetermined gain value. The priority of comparing the predetermined gain value with the gain value to turn on/off the antenna current supply 340 can be designed to be higher than that of comparing the predetermined CNR/SNR value with the detected CNR/SNR value. A complete description is detailed in the following paragraph.

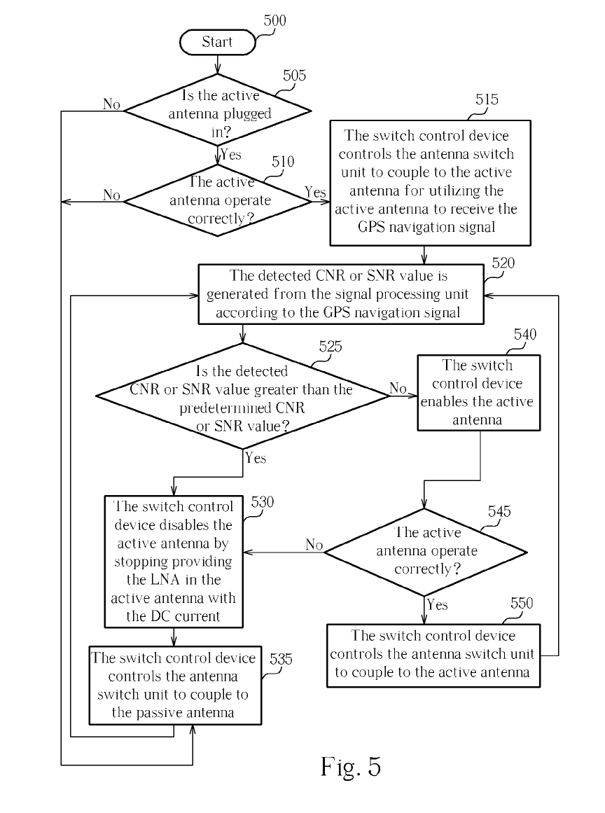

With regards to achieving optimal power efficiency, the comparison unit 335 compares the detected CNR/SNR value with the predetermined CNR/SNR value to determine whether it is required to use the active antenna 225 for signal reception. When the detected CNR/SNR value is greater than the predetermined CNR/SNR value, the comparison unit 335 controls the antenna switch unit 110 to couple to the passive antenna 125 (i.e. the antenna switch unit 110 will be switched from the active antenna 225 to the passive antenna 125 or be maintained to couple to the passive antenna 125). This is because the detected CNR/SNR value, which is greater than the predetermined CNR/SNR value, means that energy of the GPS navigation signal Sᵢₙ is not weak at the current time and therefore it is sufficient to utilize only the passive antenna 125 for signal reception. Otherwise, when the detected CNR/SNR value is not greater than the predetermined CNR/SNR value, the comparison unit 335 still controls the antenna switch unit 110 to couple to the active antenna 225, to use the active antenna 225 for signal reception. Please refer to FIG. 5. FIG. 5 is a flowchart showing an operation of the antenna switching system 300 for achieving optimal power efficiency. A description with respect to the flowchart is detailed as follows:
Step 500: Start.
Step 505: Is the active antenna 225 plugged in? If the active antenna 225 is plugged in, go to Step 510; otherwise, go to Step 535.
Step 510: Does the active antenna 225 operate correctly? If the active antenna 225 operates correctly, go to Step 515; otherwise, disable the active antenna 225 and then go to Step 535.
Step 515: The switch control device 305 controls the antenna switch unit 110 to couple to the active antenna 225 for utilizing the active antenna 225 to receive the GPS navigation signal Sᵢₙ.
Step 520: The detected CNR/SNR value is generated from the signal processing unit 345 according to the GPS navigation signal Sᵢₙ.
Step 525: Is the detected CNR/SNR value greater than the predetermined CNR/SNR value? If the detected CNR/SNR value is greater than the predetermined CNR/SNR value, go to Step 530; otherwise, go to Step 540.
Step 530: The switch control device 305 disables the active antenna 225 by stopping providing the LNA 230 in the active antenna 225 with the DC current.
Step 535: The switch control device 305 controls the antenna switch unit 110 to couple to the passive antenna 125.
Step 540: The switch control device 305 enables the active antenna 225.
Step 545: Does the active antenna 225 operate correctly? If the active antenna 225 operates correctly, go to Step 550; otherwise, go to Step 530.
Step 550: The switch control device 305 controls the antenna switch unit 110 to couple to the active antenna 225.

According to the steps shown in FIG. 5, the switch control device 305 can monitor the detected CNR/SNR value corresponding to the GPS navigation signal Sᵢₙ constantly, for selectively utilizing the active antenna 225 or passive antenna 125 for signal reception to achieve optimal power efficiency. For example, suppose that the predetermined CNR/SNR value is specified to be 40 dBc/Hz and a gain of the LNA 230 is defined as 30 dB. Usually, in an open-skywide-area (e.g. on the freeway in a rural area), power of the GPS navigation signal Sᵢₙ can reach −125 dBm, and the antenna switch unit 110 is coupled to the passive antenna 125 to utilize the passive antenna 125 for signal reception since the detected CNR/SNR value corresponding to the GPS navigation signal Sᵢₙ is greater than 40 dBc/Hz no matter whether the active antenna 225 or the passive antenna 125 is used. In practice, the detected CNR/SNR value by utilizing the active antenna 225 or the passive antenna 125 for signal reception can reach 48 dBc/Hz or 43 dBc/Hz respectively. When the antenna switching system 300 is in a city area, there is a possibility that the detected CNR/SNR generated by using the passive antenna 125 is lower than 40 dBc/Hz due to buildings in the city area. In this situation, the switch control device 305 controls the antenna switch unit 100 to couple to the active antenna 225 instead of the passive antenna 125.

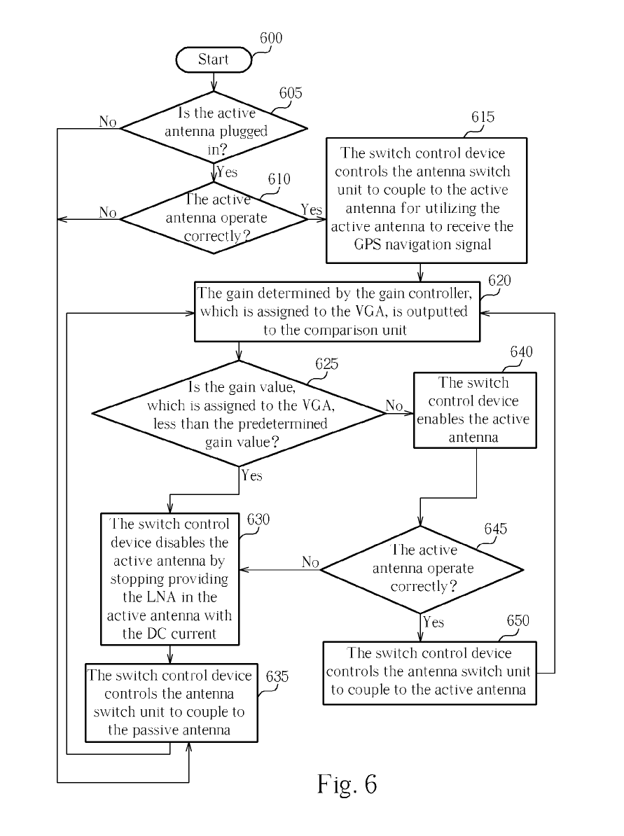

For achieving anti-jamming, the comparison unit 335 compares the gain value with the predetermined gain value to determine whether it is necessary to use the active antenna 225 for signal reception. When the gain value is less than the predetermined gain value, the comparison unit 335 controls the antenna switch unit to couple to the passive antenna 125 (i.e. the antenna switch unit 110 will be switched from the active antenna 225 to the passive antenna 125). This is because when the gain value is less than the predetermined gain value, a jamming signal source often exists nearby such that the signal processing unit 345 may be saturated due to the jamming signal source. The antenna switching 300 consequently uses the passive antenna 125 instead of the active antenna 225 for signal reception. Otherwise, when the gain value is not less than the predetermined gain value, the comparison unit 335 still controls the antenna switch unit 110 to couple to the active antenna 225, to use the active antenna 225 for signal reception. Please refer to FIG. 6. FIG. 6 is a flowchart showing an operation of the antenna switching system 300 for achieving anti-jamming. A description with respect to the flowchart is detailed as follows:

Step 600: Start.
Step 605: Is the active antenna 225 plugged in? If the active antenna 225 is plugged in, go to Step 610; otherwise, go to Step 635.
Step 610: Does the active antenna 225 operate correctly? If the active antenna 225 operates correctly, go to Step 615; otherwise, disable the active antenna 225 and then go to Step 635.
Step 615: The switch control device 305 controls the antenna switch unit 110 to couple to the active antenna 225 for utilizing the active antenna 225 to receive the GPS navigation signal Sᵢₙ.
Step 620: The gain determined by the gain controller 330, which is assigned to the VGA 320, is outputted to the comparison unit 335.
Step 625: Is the gain value, which is assigned to the VGA 320, less than the predetermined gain value? If the gain value assigned to the VGA 320 is less than the predetermined gain value, go to Step 630; otherwise, go to Step 540.
Step 630: The switch control device 305 disables the active antenna 225 by stopping providing the LNA 230 in the active antenna 225 with the DC current.
Step 635: The switch control device 305 controls the antenna switch unit 110 to couple to the passive antenna 125.
Step 640: The switch control device 305 enables the active antenna 225.
Step 645: Does the active antenna 225 operate correctly? If the active antenna 225 operates correctly, go to Step 650; otherwise, go to Step 630.
Step 650: The switch control device 305 controls the antenna switch unit 110 to couple to the active antenna 225.

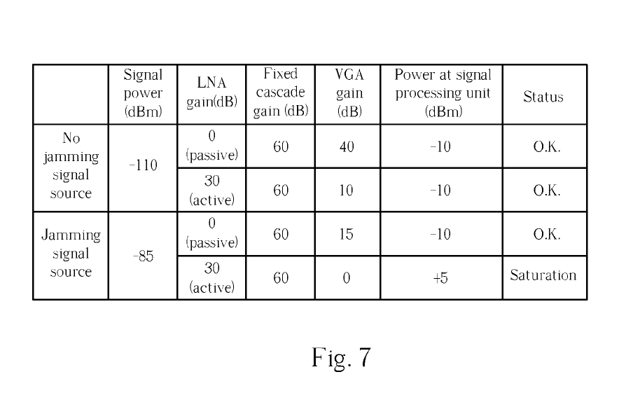

In accordance with the steps shown in FIG. 6, the switch control device 305 can monitor the gain value assigned to the VGA 320 constantly, for selectively using one of the active antenna 225 and passive antenna 125 for signal reception to achieve anti-jamming. Please refer to FIG. 7. FIG. 7 shows a table illustrating various examples of receiving the GPS navigation signal Sᵢₙ in different environments by using the active antenna 225 or the passive antenna 125. As shown in FIG. 7, suppose that a gain of the LNA 230 is equal to 30 dB and a variable gain range of the VGA 320 is from zero to 50 dB. It is also assumed that a signal gain passing through the down conversion module 315 is fixed and equal to 60 dB, and the requirement of the signal processing unit 345 is detailed in the following: the signal level of the output signal from the VGA 320 requires exceeding −10 dBm (i.e. 100 mV) and cannot exceed −3 dBm (i.e. 200 mV). Firstly, considering that no jamming signal source exists near the antenna switching system 300, either the active antenna 225 or the passive antenna 125 can be used for signal reception since it is easy to meet the requirement of the signal processing unit 345 by controlling the gain value assigned to the VGA 320 at 10 dB or 40 dB (as shown in FIG. 7). However, considering that a jamming signal source exists nearby (power of this jamming signal source is equal to −85 dBm), using the passive antenna 125 for signal reception can still easily meet the requirement of the signal processing unit 345, but it is impossible to meet the requirement of the signal processing unit 345 for utilizing the passive antenna 125 for signal reception. This is because the signal level (5 dBm) of the output signal from the VGA 320 is still greater than −3 dBm even though the gain value assigned to the VGA 320 is adjusted to become zero. Therefore, in this situation, the switch control device 305 controls the antenna switch unit 110 to switch from the active antenna 225 to the passive antenna 125 for signal reception, to avoid being saturated by the above-mentioned jamming signal source.

Of course, the antenna switching system 300 can also simultaneously operate for achieving optimal power efficiency and anti-jamming. That is, the steps shown in FIG. 6 and in FIG. 5 can be combined. This also falls within the scope of the present invention. Furthermore, although the antenna switch unit 110 is implemented by an RF switch in the above-mentioned embodiment, the antenna switch unit 110 can also be implemented by a power combiner in another embodiment. The reason is that it is easy for the switch control device 305 to control the power combiner to only receive the GPS navigation signal Sᵢₙ from the passive antenna 125, by stopping providing the DC current for the active antenna 225.

Those skilled in the art will readily observe that numerous modifications and alterations of the device and method may be made while retaining the teachings of the invention.

What is claimed is:

1. An antenna switching system for switching between a first antenna and a second antenna, the antenna switching system comprising:
an antenna switch unit, selectively coupled to the first antenna or the second antenna; and
a switch control device, coupled to the antenna switch unit, for controlling the antenna switch unit to switch between the first antenna and the second antenna according to at least a predetermined threshold value and an incoming wireless signal received from the antenna switch unit;
wherein a gain of the first antenna is different from a gain of the second antenna.

2. The antenna switching system of claim 1, being a GNSS receiving system.

3. The antenna switching system of claim 1, wherein one of the first antenna and the second antenna is an active antenna, and the other of the first antenna and the second antenna is a passive antenna.

4. The antenna switching system of claim 1, wherein the predetermined threshold value is a predetermined CNR/SNR value, and the switch control device comprises:
a signal processing unit, coupled to the antenna switch unit, for generating a detected CNR/SNR value corresponding to the incoming wireless signal received from the antenna switch unit;
a control unit, for setting the predetermined CNR/SNR value; and
a comparison unit, coupled to the signal processing unit and the control unit, for receiving the detected CNR/SNR value from the signal processing unit and controlling the antenna switch unit to switch between the first antenna and the second antenna by comparing the detected CNR/SNR value with the predetermined CNR/SNR value.

5. The antenna switching system of claim 4, wherein the comparison unit controls the antenna switch unit to couple to the second antenna when the detected CNR/SNR value is greater than the predetermined CNR/SNR value; and the comparison unit controls the antenna switch unit to couple to the first antenna when the detected CNR/SNR value is not greater than the predetermined CNR/SNR value.

6. The antenna switching system of claim 1, wherein the predetermined threshold value is a predetermined gain value, and the switch control device comprises:
a variable gain amplifier, for amplifying the incoming wireless signal received from the antenna switch unit;
a gain controller, coupled to the variable gain amplifier, for determining a gain value assigned to the variable gain amplifier;
a control unit, for setting the predetermined gain value; and
a comparison unit, coupled to the gain controller and the control unit, for receiving the gain value determined by the gain controller, and for controlling the antenna switch unit to switch between the first antenna and the second antenna by comparing the gain value with the predetermined gain value.

7. The antenna switching system of claim 6, wherein the gain of the first antenna is greater than the gain of the second antenna, and the comparison unit controls the antenna switch unit to couple to the second antenna when the gain value is less than the predetermined gain value; and the comparison unit controls the antenna switch unit to couple to the first antenna when the gain value is not less than the predetermined gain value.

8. An antenna switching method, comprising:
providing a first antenna and a second antenna, where a gain of the first antenna is different from a gain of the second antenna;
providing an antenna switch unit selectively coupled to the first antenna or the second antenna; and
controlling the antenna switch unit to switch between the first antenna and the second antenna according to at least a predetermined threshold value and an incoming wireless signal received from the antenna switch unit.

9. The antenna switching method of claim 8, being applied to a GNSS receiving system.

10. The antenna switching method of claim 8, wherein the step of
providing the first antenna and the second antenna comprises: providing an active antenna and a passive antenna.

11. The antenna switching method of claim 8, wherein the predetermined threshold value is a predetermined CNR/SNR value, and the step of controlling the antenna switch unit to switch between the first antenna and the second antenna comprises:
generating a detected CNR/SNR value corresponding to the incoming wireless signal received from the antenna switch unit;
setting the predetermined CNR/SNR value; and
receiving the detected CNR/SNR value from the signal processing unit and controlling the antenna switch unit to switch between the first antenna and the second antenna by comparing the detected CNR/SNR value with the predetermined CNR/SNR value.

12. The antenna switching method of claim 11, wherein the gain of the first antenna is greater than the gain of the second antenna, and the step of controlling the antenna switch unit to switch between the first antenna and the second antenna comprises:
controlling the antenna switch unit to couple to the second antenna when the detected CNR/SNR value is greater than the predetermined CNR/SNR value; and
controlling the antenna switch unit to couple to the first antenna when the detected CNR/SNR value is not greater than the predetermined CNR/SNR value.

13. The antenna switching method of claim 8, wherein the predetermined threshold value is a predetermined gain value, and the step of controlling the antenna switch unit to switch between the first antenna and the second antenna comprises:
providing a variable gain amplifier, and utilizing the variable gain amplifier to amplify the incoming wireless signal received from the antenna switch unit;
determining a gain value assigned to the variable gain amplifier;
setting the predetermined gain value; and
receiving the gain value assigned to the variable gain amplifier and controlling the antenna switch unit to switch between the first antenna and the second antenna by comparing the gain value with the predetermined gain value.

14. The antenna switching method of claim 13, wherein the step of controlling the antenna switch unit to switch between the first antenna and the second antenna comprises:
controlling the antenna switch unit to couple to the second antenna when the gain value is less than the predetermined gain value; and
controlling the antenna switch unit to couple to the first antenna when the gain value is not less than the predetermined gain value.
